(19) United States
(12) Patent Application Publication
(10) Pub. No.: US 2005/0114418 A1
(43) Pub. Date: May 26, 2005

(54) Efficient convolution method with radially-symmetric kernels

(75) Inventor: John E. Rosenstengel, Beavercreek, OH (US)

Correspondence Address: John E. Rosenstengel, 3685 Olde Willow Drive, Beavercreek, OH, 45431, US

(73) Assignee: John E. Rosenstengel

(21) Appl. No.: 10/997,513

(22) Filed: Nov. 24, 2004

Related U.S. Application Data
(60) Provisional application No. 60/524,713, filed on Nov. 24, 2003.

(51) Int. Cl. G06F 17/10

(52) U.S. Cl. 708/315

(57) ABSTRACT

A method for filtering an array of input data with a radially-symmetric convolution (RSC) kernel that leverages the symmetry in the kernel to minimize the number of mathematical computations necessary to compute a result. The invention uses only the unique values in the convolution kernel to compute all multiplications necessary for one input row at a time. Once the input row is multiplied by all unique values, the results are stored in data structures specialized to represent all of the impact the input row will have on the output. Therefore, the input row is read once and then discarded.

### CROSS-REFERENCE TO RELATED APPLICATIONS

This application claims the benefit of U.S. Provisional Application No. 60/524,713, filed Nov. 24, 2003, incorporated herein by reference.

### BACKGROUND OF THE INVENTION

A. Field of the Invention

The present invention relates to methods for improving speed of filtering operations in digital image processing applications.

B. Background

Convolution is an integral part of image processing, representing the engine of filtering applications. In image processing systems that must deal with large data structures, the complexity and computational requirements of convolution present problems for the system developer. These problems are discussed at length in a variety of texts on the subject.

Most signal and image processing texts recommend Fast Fourier Transforms (FFTs) to implement convolution on large and/or multi-dimensional data structures. Direct convolution is seldom recommended for these applications because its computational requirements grow on the order of O(MN) (where M≡# of elements in the target image and N≡# of elements in the kernel). Compared to FFT-based convolution's growth rate of O(M log₂(M)) (assuming N<M) direct convolution is impractical except for cases where N<<M.

There are several factors to consider when deciding which convolution method to use. Table 1 on the following page shows many of these. However, in cases where the target data structure is much larger (orders of magnitude larger) than the kernel size, direct convolution should be given strong consideration.

One widely used direct convolution method is separable kernel convolution (SKC). SKC's growth rate is O(M\sqrt{N}), making SKC the recommended solution in cases where N<log₂(M). However, only a small subset of convolution kernels are separable.

To be ‘separable,’ a convolution kernel must be able to be represented by a single row and column combination. This is tested by taking the singular value decomposition (SVD) of the kernel. SVD returns an eigenvalue matrix that can be checked for separability. If the first eigenvalue is approximately 100% (within numeric precision) of the sum of the eigenvalues, then the first column of the ‘U’ matrix and first row of the ‘V’ matrix can be used to represent the full kernel. Several types of convolution kernels of broad interest fail this condition, and are not separable.

TABLE 1
Factors For Choosing Convolution Methods

| Factor | FFT-based Convolution | Direct Convolution | Advantage |
|---|---|---|---|
| Memory Requirements | Each dimension of target must be padded | Minimum footprint. | Direct |
| | to an integer power of 2. Kernel must be | | |
| | equivalent size to padded target. | | |
| Memory Access | For multiple dimensions memory access | Linear, contiguous accesses. | Direct |
| | approaches random. | | |
| Number of Kernels | After implementing the first kernel, subsequent | Each kernel requires an equal amount of | FFT |
| | kernels only require approximately | computation. | |
| | ½ the operations. | | |
| Size of Kernel | As long as the kernel is equal to or smaller | As strongly affected by kernel size as target | Varies |
| | than the target, no change to computations. | size. | |

Many convolution kernels that are not separable have a high degree of symmetry. It should be possible to leverage the symmetry of these kernels, even though they are not ‘separable.’ To do this, we define a kernel type where all values at the same radial distance from the centroid of the kernel are identical (Equation 1). For a radially-symmetric kernel, the number of unique kernel values (ψ(ε) from Equation 5 on the following page) approaches N/8 as N approaches infinity.

A reduced number of multiplies are required for this radially-symmetric convolution kernel because in a standard direct convolution, each target value will be multiplied by an identical kernel value as many as eight times. With this in mind, a convolution routine could be developed that extends the competitive advantage of direct convolution over FFT-based convolution well past the point where N<<M. Further, this algorithm would be applicable to more convolution kernel types than SKC and be easily vectorized. 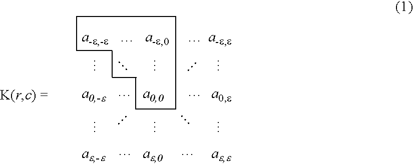
where:
K(r,c)≡\sqrt{N}×\sqrt{N} kernel where \sqrt{N} is an odd integer (2)
ε≡(\sqrt{N}−1)/2 (3)

$$\begin{matrix}Radial \text{-} symmetry ⇒ ( \begin{matrix}∀ x , y : ℨ \vert ( - ɛ \leq x \leq ɛ ) ⩓ ( - ɛ \leq y \leq ɛ ) : ⋯ \\ ( {a}_{x , y} = a \pm x , \pm y ) ⩓ ( {a}_{x , y} = {a}_{\pm y , \pm x} )\end{matrix} ) & ( 4 ) \\ ψ ( ɛ ) = {\sum }_{i = 0}^{ɛ} ( i + 1 ) ( \# of unique values ) & ( 5 )\end{matrix}$$

The growth rate for a radially-symmetric convolution (RSC) kernel remains the O(MN) rate of direct convolution, however the number of multiplies approaches

$$\frac{{1}^{th}}{8}$$

of those required for direct convolution. Therefore, to decide if RSC will be the most efficient convolution method for a given problem, estimate the total number of floating point operations required for each of the different methods across expected target and kernel sizes. And then give full consideration to the additional factors from Table 1 on page 3.

To make an estimate of the potential advantages of RSC for a 2 dimensional problem (i.e. mammography computer-aided detection) a range of expected target and kernel sizes are predicted. FIG. 1 on page 42 was created with the estimates of breast content made by the an autocropper from a commercially-available mammography computer-aided detection system on a database of 5,627 digitized mammograms. Mammograms were digitized at an inter-pixel spacing of 43.5 μm. Further, the requisite padding to the next power of two was added to the image sizes to allow estimation of the requirements for FFT-based convolution.

Given these estimates of image sizes, FFT-based convolution requirements were estimated, in floating-point operations (FLOPs) and seconds of execution time (Table 2 on the next page). Weighting the estimated execution times by the frequency of observed image sizes from the Autocropper results (FIG. 1 on page 42), the FFT-based convolution can be expected to require 192 seconds per image on average (min—18 seconds, max—600 seconds).

TABLE 2
FFT-based Convolution Requirements

| # Rows | # Cols | FLOPs | Time (sec) | Memory (Mb) |
|---|---|---|---|---|
| 4096 | 1024 | 0.8 × 10⁹ | 18 | 32 |
| 4096 | 2048 | 1.6 × 10⁹ | 47 | 64 |
| 4096 | 4096 | 3.3 × 10⁹ | 116 | 128 |
| 8192 | 1024 | 1.5 × 10⁹ | 40 | 64 |
| 8192 | 2048 | 3.2 × 10⁹ | 105 | 128 |
| 8192 | 4096 | 6.8 × 10⁹ | 250 (est.) | 256 |
| 8192 | 8192 | 14 × 10⁹ (est.) | 600 (est.) | 512 |

All measured values were computed with MATLAB®) R11.1 on a Pentium III with 786 MB SDRAM. Estimated values are used when memory allocation failed, and/or swap space was required.

FIG. 2 on page 43 shows the predicted FLOPs required by four different convolution methods for image sizes considered ‘average’ (FIG. 2(a)), ‘smallest’ (FIG. 2(b)), and ‘largest’ (FIG. 2(c)), using the data from FIG. 1 on page 42. This result predicts that RSC will require less FLOPs than FFT-based convolution for kernel sizes up to 25×25. Also, other efficiencies (see Table 1 on page 3) should give RSC an advantage over FFT-based convolution well beyond this kernel size.

One further note is that, in almost all cases where a convolution kernel is separable, SKC is recommended. However, the RSC may be used on the SKC algorithm in each dimension to further reduce the number of mathematical operations.

While the description herein details the 2D implementation, the basic concept applies to convolution kernels of any dimension. As dimensions are increased (going from 2D to 3D processing) the benefit of these methods on radially-symmetric kernels is amplified. Where the number of redundant multiplies approaches 8× for a 2D kernel, a similar 3D kernel has redundant multiplies approaching 48×. The equation for higher dimensions is 2^{D}×D! where D≡# of dimensions.

Also, while separable kernel convolution has a distinct advantage over RSC in 2D, I have never seen a mathematical treatment of higher dimensional kernels being separated.

### SUMMARY OF THE INVENTION

Accordingly, the present invention provides a method for fast filtering of digital images when the filter is represented as a radially-symmetric convolution kernel.

The invention uses only the unique values in the convolution kernel to compute all multiplications necessary for one input row at a time. Once the input row is multiplied by all unique values, the results are stored in data structures specialized to represent all of the impact the input row will have on the output. Therefore, the input row is read once and then discarded.

The invention leverages the symmetry and defined data structures to compute output rows with the minimum number of mathematical operations possible.

### BRIEF DESCRIPTION OF THE DRAWINGS

The accompanying drawings, which are included to provided a further understanding of the invention.

FIG. 1—Histogram of Cropped Image Sizes. Computed from an Autocropper results on 5,627 images. ‘Unpadded’ sizes may be used by all direct convolution methods, while FFT-based convolution requires ‘Padded’ images.

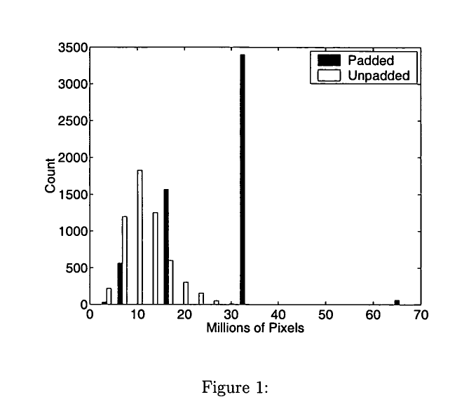

FIG. 2—Floating Point Operations (FLOPs) Required By Different Convolution Routines Versus Kernel Width. ‘Average,’ ‘Smallest,’ and ‘Largest’ were computed from an Autocropper results on 5,627 images.

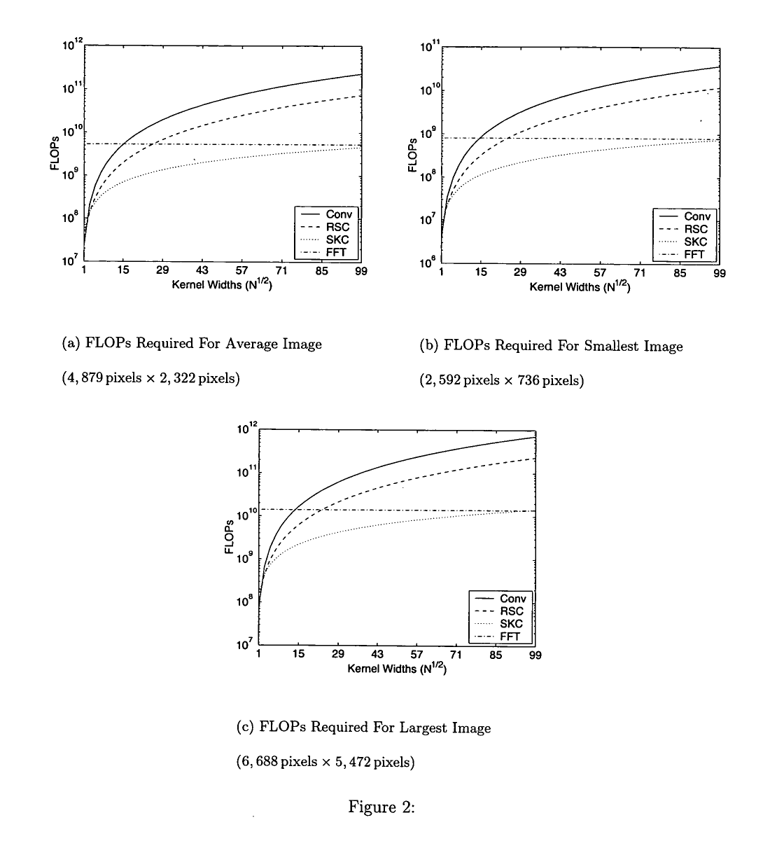

FIG. 3—Kernel Overlap Demonstration. A 5×5 convolution kernel is depicted as it moves down target row 10, while computing result row 10. Input rows 8-12 are the only rows affecting the result.

FIG. 4—Scalar Radially-symmetric Convolution (RSC) Top-level Data Flow Diagram (DFD).

FIG. 5—Scalar Initialize KIS Data Flow Diagram (DFD).

FIG. 6—Scalar Load Next RIS Data Flow Diagram (DFD).

FIG. 7—Scalar Compute Result Row Data Flow Diagram (DFD).

FIG. 8—Microsoft®) Excel 2000 Spreadsheet Graphical Example Input.

FIG. 9—Example Row Impact Structure (RIS 0).

FIG. 10—Example Row Impact Structure (RIS 1).

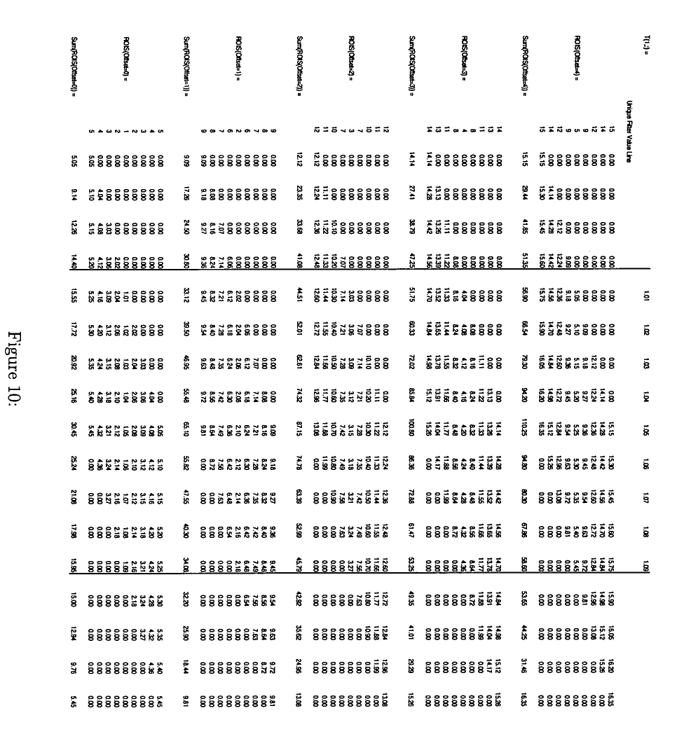

FIG. 11—Example Row Impact Structure (RIS 2).

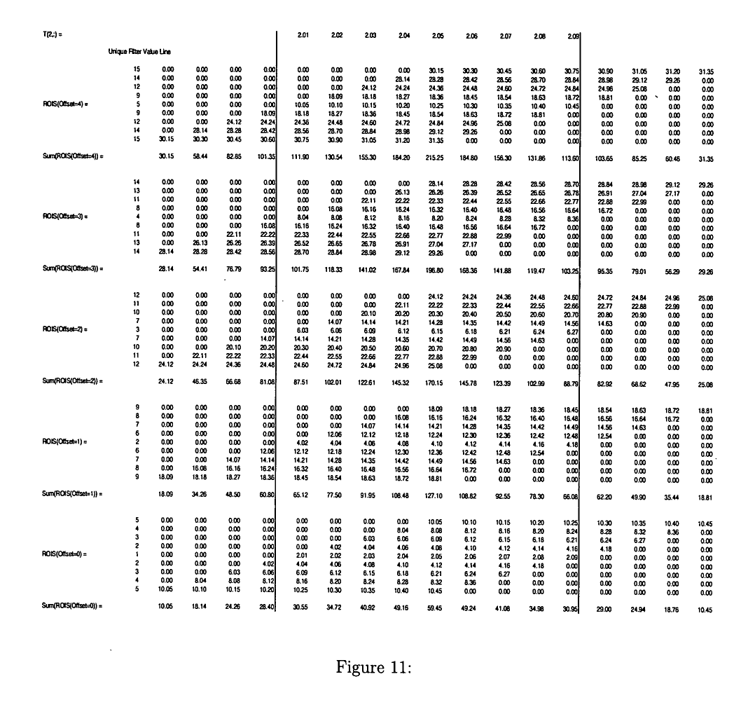

FIG. 12—Example Row Impact Structure (RIS 3).

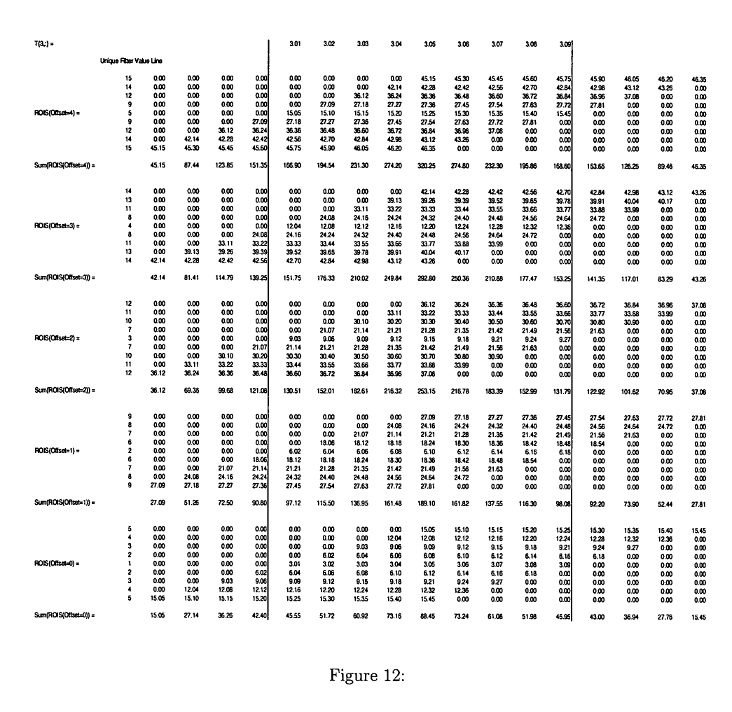

FIG. 13—Example Row Impact Structure (RIS 4).

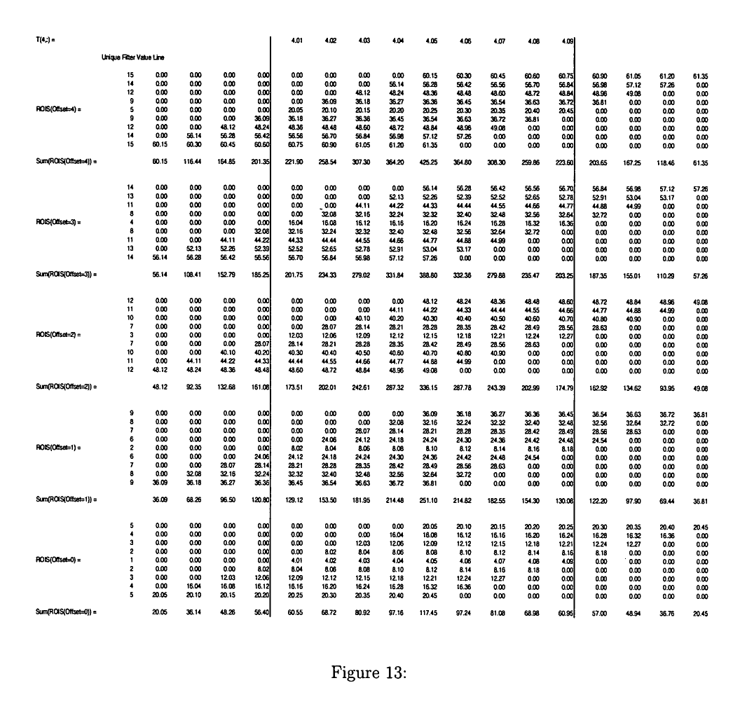

FIG. 14—Example Row Impact Structure (RIS 5).

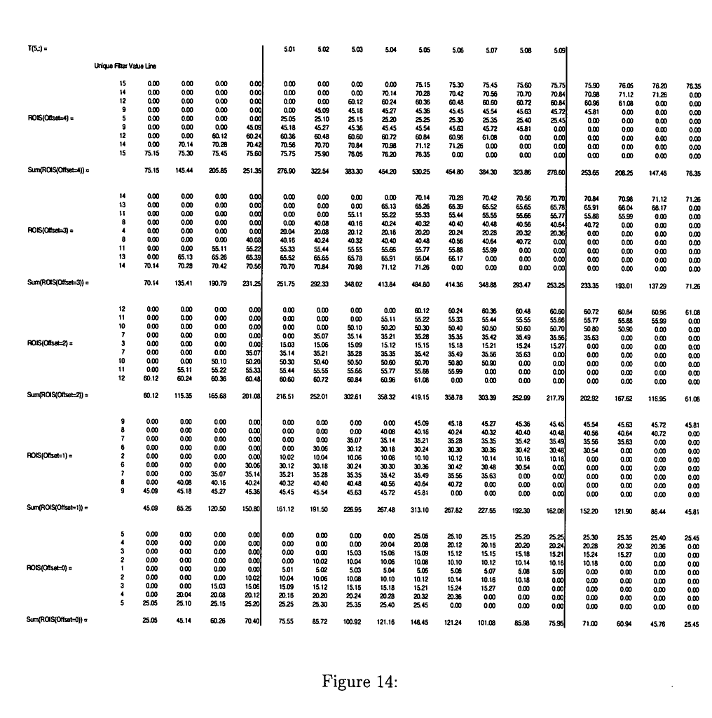

FIG. 15—Example Row Impact Structure (RIS 6).

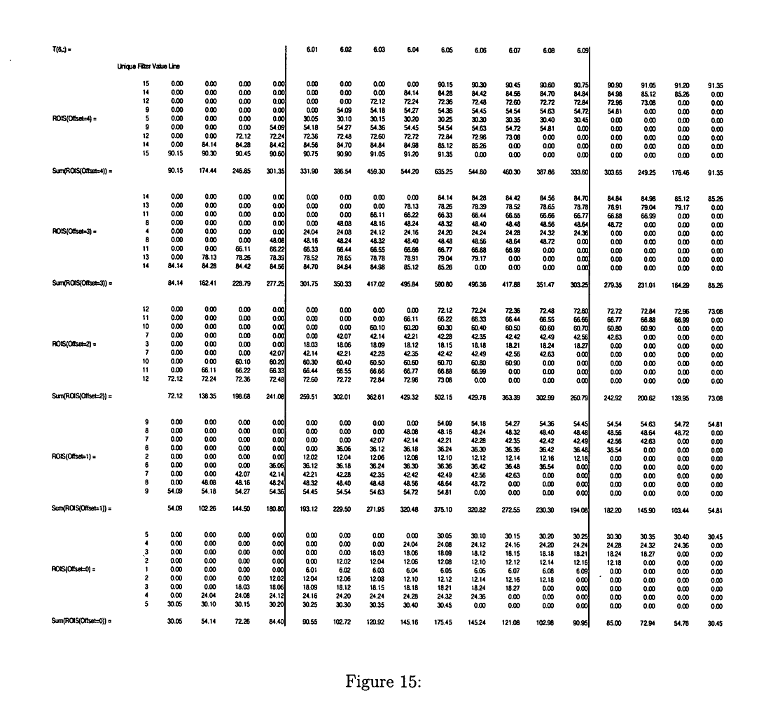

FIG. 16—Example Row Impact Structure (RIS 7).

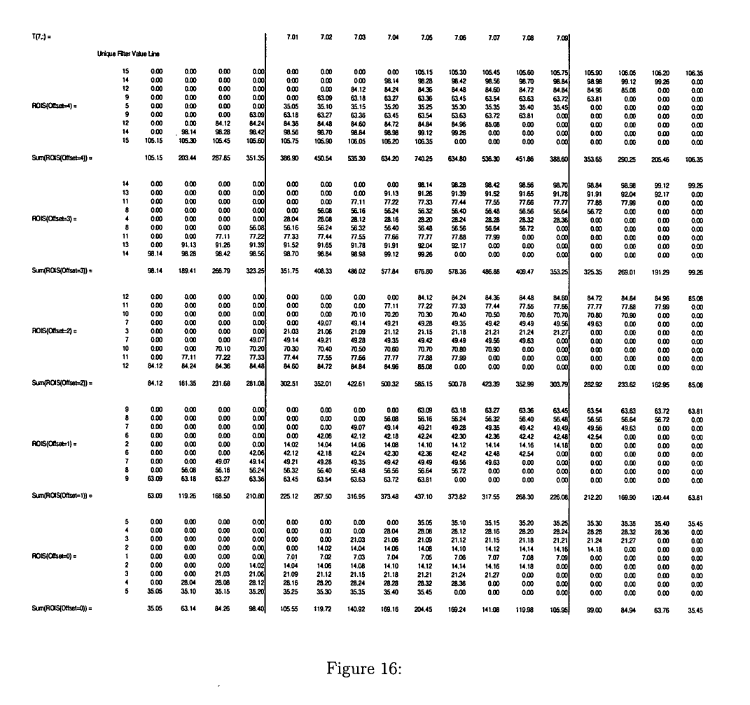

FIG. 17—Example Row Impact Structure (RIS 8).

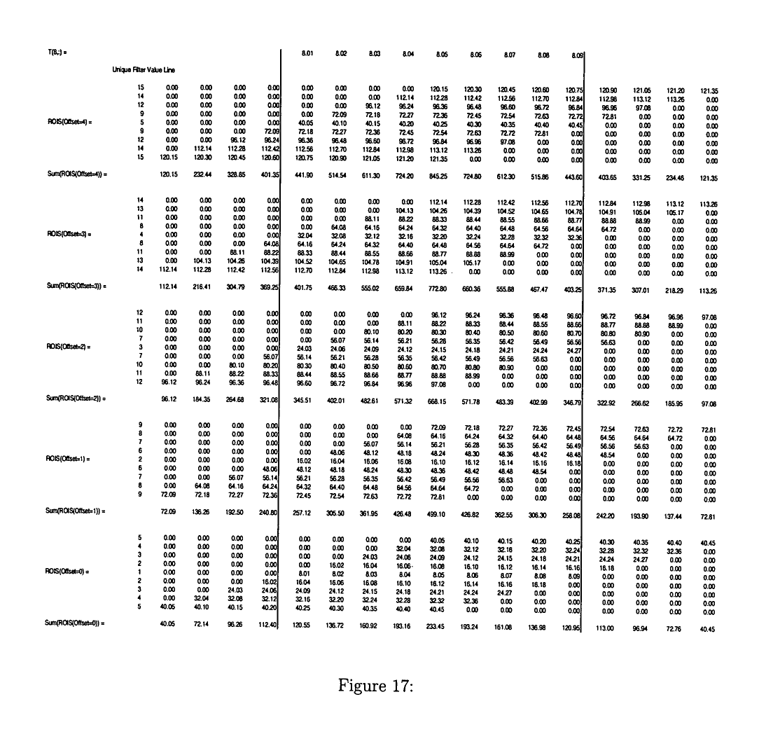

FIG. 18—Computing Result Example.

FIG. 19—Example Result.

FIG. 20—Vectorization of the Kernel Influence Structure. The KIS is a revolving data structure where the distance (offset) from the current result row determines which summed row offset structure (SROIS) is included from each target row. The vectorized KIS shown is for a 3×3 kernel.

FIG. 21—Vectorized Radially-symmetric Convolution (RSC) Top-level Data Flow Diagram (DFD).

FIG. 22—Vectorized Load Next RIS Data Flow Diagram (DFD).

FIG. 23—Implement Start Block Kernel Data Flow Diagram (DFD).

FIG. 24—Example Vector Load Registers-Start. The row impact structure (RIS) shown is for a 7×7 convolution kernel which contains 4 row offset impact structures (ROISs) by definition. The unique kernel values are shown on the left in bold. The double lines indicate where the result will be cropped. The numbers in the ROISs indicate the target row columns to be multiplied by the unique kernel values and summed into the summed row impact structures (SROISs). The boxes indicate the first set of vector registers as they will be loaded.

FIG. 25—Implement Block Kernel Data Flow Diagram (DFD).

FIG. 26—Example Vector Registers Containing The Pre-summed Target Row Values Of A Folded Row Impact Offset Structure (ROIS).

FIG. 27—Implement Finish Block Kernel Data Flow Diagram (DFD).

FIG. 28—Example Vector Load Registers-Finish. The row impact structure (RIS) shown is for a 7×7 convolution kernel which contains 4 row offset impact structures (ROISs) by definition. The unique kernel values are shown on the left in bold. The double lines indicate where the result will be cropped. The numbers in the ROISs indicate the target row columns to be multiplied by the unique kernel values and summed into the summed row impact structures (SROISs). The boxes indicate the first set of vector registers as they will be loaded.

### DETAILED DESCRIPTION OF THE PREFERRED EMBODIMENTS

Reference will now be made in detail to the preferred embodiments of the present invention, examples of which are illustrated in the accompanying drawings.

A. Scalar Radially-Symmetric Convolution Data Structures

Given the radially-symmetric convolution kernel defined in Equation 1 on page 4 and applying Equation 4 on page 5 we can express a 5×5 radially-symmetric convolution kernel as in Equation 6 (the six unique kernel values are encircled).

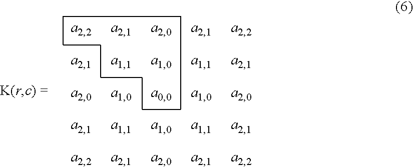

Radially-symmetric convolution kernels may contain multiple (up to 8—as for a_{2,1} in Equation 6) duplicate values for each specific row offset and column offset from the centroid. This redundancy is exploited by only multiplying each target value by each unique kernel value once, and adding the product into the result in multiple locations. The data structures that follow will ensure that these products are properly reused in the computation of the convolution result.

It is possible and advantageous to define a data structure that represents the result of multiplying an entire target row by a single unique kernel value (Unique Kernel Value Result (UKVR)—see Equation 7). This is possible because the products from adjacent target values (column-wise) are always added into the result in adjacent (column-wise) positions. The UKVR captures the impact that each ‘target row’ and ‘unique kernel value’ combination will have on the convolution result.
UKVR(rₜ, rₖ, cₖ)={∀cₜ: [symbol] |(0≦cₜ<#(cₜ)): (aᵣ_{ₖ}_{,c}_{ₖ}×T(rₜ, cₜ))} (7)
or
UKVRᵣ_{ₜ}_{,r}_{ₖ}_{,c}_{ₖ}={(aᵣ_{ₖ}_{,c}_{ₖ}×Tᵣ_{ₜ}_{,0}), . . . (aᵣ_{ₖ}_{,c}_{ₖ}×Tᵣ_{ₜ},(#(c_{ₜ}₎₋₁₎)} (8)
where:
rₜ≡target row (9)
cₜ=target column (10)
rₖ≡kernel row (11)
cₖ≡kernel column (12)
#(cₜ)≡total number of target columns (13)
aᵣ_{_{k,c}}_{ₖ}≡unique kernel value at kernel row rₖ and column cₖ (14)
T(r,c)≡target value at row r and column c (15)

To ensure that each UKVR is added into the convolution result at all proper locations for each particular row of the convolution result, R(r_{r,}:), we define a Row Offset Impact Structure (ROIS). The ROIS is intended to capture the impact that a particular target row, T(rₜ,:), will have on a particular result row, R(rᵣ,:). The ROIS is formally defined in Equation 16.
ROIS(rₜ,rᵣ)≡(T(rₜ,:)→R(rᵣ,:)) (16)
or:
ROISᵣ_{ₜ},r_{ᵣ} (r,c)≡the value stored at the r^{th} row and c^{th} column of ROIS (rₜ,rᵣ) (17)
where:
:≡all rows or cols, based on placement (18)

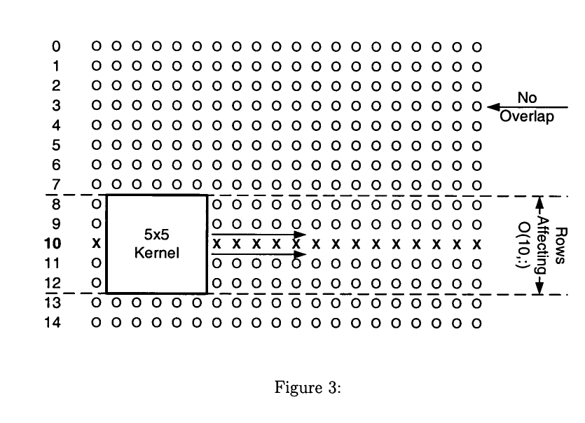

Before we proceed, we must consider the relationship between target rows and result rows for convolution. This relationship is depicted in FIG. 3 on page 44. During the computation of a particular result row, the convolution kernel is centered on the corresponding target row (row 10 in the demonstration). The kernel is then moved from left to right, being centered on each target column to compute the value for the corresponding result column.

The convolution kernel depicted in FIG. 3 has a dimension of 5×5, corresponding to an ε (from Equation 3 on page 4) of 2. The value ε is referred to as either the ‘maximum overlap’ (to specify the number of target rows or columns the kernel can overlap from its centroid) or the ‘maximum offset’ (to specify the maximum distance a target row or column can be from the kernel's centroid and still affect the result corresponding to this centroid).

To illustrate the kernel-centric relationship between target row/column and result row/column and allow us to exploit inherent symmetries, Equation 16 is rewritten based upon offsets from the kernel centroid (Equation 19 on the next page). From this point on, we concern ourselves mainly with the relative relationship of rows and columns as offsets from the kernel centroid.
ROISᵣ_{ₜ}_{,r}_{ₒ}≡(T(rₜ,:)→R(rᵣ,:)) (19)
where:
rₒ=rᵣ−rt (20)
also:
(|rₒ|>ε)→(ROISᵣ_{ₜ}_{,r}_{ₒ}≡{ }) (21)

Equation 21 implies that there can be no more non-null ROISs for a given row than the number of rows in the convolution kernel (\sqrt{N} from Equation 2 on page 4). This is shown in FIG. 3 on page 44 where target row 3 is not overlapped by the kernel and therefore has no impact on the convolution result at the kernel's current position.

Another characteristic of convolution is that the relationship between a target row and a result row utilizes only the kernel values from the kernel row overlapping the target row. For example, row 8 (from FIG. 3) is only multiplied by the kernel values from kernel row 0.

Each ROIS contains every UKVR relating a single target row to a single row of the convolution result. This means that each ROIS can be defined as containing the \sqrt{N} UKVRs represented as ‘UKVRᵣ_{ₜ}_{,r}_{_{o,:}}’ in this document. For convenience, we will arrange them in rows of the ROIS.

At this point, it might seem that the ROIS should have \sqrt{N} rows and # (cᵣ) columns (the number of target columns). However, by convention, the convolution result contains #(rₜ)+2ε rows and #(cₜ)+2ε columns, because the kernel runs ε rows and columns off the target on all sides. The ROIS must have the same number of columns as for standard convolution, with zero values representing kernel elements that would be extended off of the target.

To understanding where to place the smaller UKVR within a row of the ROIS (and thus where to pad with zeros), we need to consider that each row of the ROIS represents the result of multiplying a target row by the kernel value at a specific column (NOTE: the kernel row is determined by rₒ). To do this, we define the top row of the ROIS to be the left-most column of the kernel (aᵣ_{ₒ}_{,-ε} from Equation 1 on page 4), and order them to the right-most column (aᵣ_{ₒ}_{,ε}). Zeros are padded for the target where kernel columns extend beyond the target, as seen in Equation 22. The vertical lines show where the structure would be cropped to create a result with the same width as the target.

$$\begin{matrix}{ROIS}_{{r}_{t} , {r}_{o}} = [ \begin{matrix}0 & . . . \\ ⋮ & \\ 0 & . . . \\ ⋮ & \\ {U}_{ε} ( 0 ) & . . .\end{matrix} \vert \begin{matrix}0 & . . . & {U}_{- ε} ( 0 ) & . . . & {U}_{- ε} ( z - ε ) \\ ⋮ & & ⋮ & & ⋮ \\ {U}_{0} ( 0 ) & . . . & {U}_{0} ( ε ) & . . . & {U}_{0} ( z ) \\ ⋮ & & ⋮ & & ⋮ \\ {U}_{ε} ( ε ) & . . . & {U}_{ε} ( 2 ε ) & . . . & 0\end{matrix} \vert \begin{matrix}. . . & {U}_{- ε} ( z ) \\ & ⋮ \\ . . . & 0 \\ & ⋮ \\ . . . & 0\end{matrix} ] \\ where \text{:} & ( 22 ) \\ {U}_{x} ≡ {UKVR}_{{r}_{t} , {r}_{o} , x} & ( 23 ) \\ Equation 4 ⇒ ( ( {U}_{x} = {U}_{- x} ) ⩓ ( {ROIS}_{{r}_{t} , {r}_{o}} = {ROIS}_{{r}_{t} , - {r}_{o}} ) ) & ( 24 ) \\ ∴ {ROIS}_{{r}_{t} , {r}_{o}} = [ \begin{matrix}0 & . . . \\ ⋮ & \\ 0 & . . . \\ ⋮ & \\ {U}_{ε} ( 0 ) & . . .\end{matrix} \vert \begin{matrix}0 & . . . & {U}_{ε} ( 0 ) & . . . & {U}_{ε} ( z - ε ) \\ ⋮ & & ⋮ & & ⋮ \\ {U}_{0} ( 0 ) & . . . & {U}_{0} ( ε ) & . . . & {U}_{0} ( z ) \\ ⋮ & & ⋮ & & ⋮ \\ {U}_{ε} ( ε ) & . . . & {U}_{ε} ( 2 ε ) & . . . & 0\end{matrix} \vert \begin{matrix}. . . & {U}_{ε} ( z ) \\ & ⋮ \\ . . . & 0 \\ & ⋮ \\ . . . & 0\end{matrix} ] & ( 25 ) \\ & ( 26 )\end{matrix}$$

Equation 24 on the page before allows the full exploitation of kernel symmetry. It says that only the ψ(ε) unique UKVRs must be computed for each target row. These UKVRs are stored in ε+1 unique ROISs.

Key points to note regarding the preceding definition of the ROIS are:
Each ROIS contains the entire impact that one row of the target image will have on one row of the result image.
Description of how the UKVRs are to be zero padded and placed in the ROIS.
The ROIS is specifically designed to allow a single UKVR (row structure) to be computed only once and stored at multiple locations in one or more ROISs. This is the crux of our ability to eliminate redundant multiplication.

Now that we have arranged the ROIS to ensure proper use of all UKVRs, one further step is required before the ROIS can be used to compute a result row. We must now sum each column of the ROIS. Because Equation 24 on the preceding page allows us to create only the unique ROISs for each target row, each ROIS may be used to compute up to two result rows (representing the result rows with an offset from the target row of r_{±0}). Therefore, if we pre-sum the columns of the ROIS into a summed row offset impact structure (SROIS), then the sums may be reused without being recomputed.

At this point, the SROIS contains all of the information from the ROIS and the ROIS is unnecessary.

Given that the SROIS represents the impact a specific target row will have on a specific result row, we can organize these SROISs into a higher-level data structure that will represent the impact a single target row will have on the entire result (R(:,:)). This will be referred to as the row impact structure (RIS), and is defined in Equation 27. With this structure, a convolution algorithm can use each target row and the unique kernel values to populate its RIS, and then discard the target row.

This statement means that, with the data structures just presented, a convolution algorithm can consider each target row, in order, once and only once and then discard it. This presents a great benefit to memory management in that it provides for a single pass through contiguous memory. It presents a great benefit to throughput in that it does not require the entire image to be present before processing can be completed on any portion (allows pipelined design).
RISᵣ_{ₜ}≡(T(rₜ,:)→R(:,:)) (27)
RISᵣₜ≡{∀rₒ: [symbol] |(0≦r≦ε): (SROISᵣ_{ₜ}_{,r}_{ₒ})} (28)

To compute a result row, we require all of the RISs for target rows overlapped by the kernel whose centroid is centered on the corresponding target row. To handle these RISs, we define a data structure that contains the full impact that the entire target has on a specific result row, or the total influence of the convolution kernel at its current position (row). We will refer to this data structure as the kernel influence structure (KIS). The KIS is defined in Equation 29. The contents of the KIS are modified as the convolution kernel is moved from above the target to below. For each shift of a row, one RIS is no longer overlapped by the kernel, while a new RIS is added to the KIS. This limits the # of RISs required to be stored in the KIS at any one time to the # of rows in the convolution kernel.
KISᵣ_{ᵣ}≡(T(:,:)→R(:,rᵣ)) (29)
KISᵣ_{ᵣ}≡{∀rₜ: [symbol] ((rᵣ−ε)≦rₜ≦(rᵣ+ε)):(RISᵣ_{ₜ})} (30)
where:
RISᵣ_{ₜ}{ } if (rₜ<0)V(rₜ>(#(rₜ)−1)) (31)
B. Scalar Radially-Symmetric Convolution Data Flow

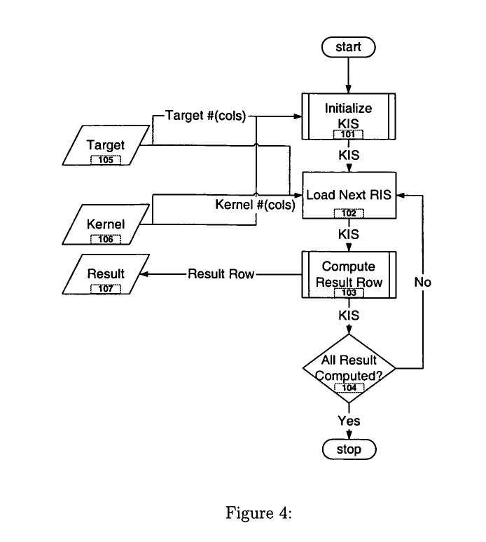

The top-level data flow is shown in FIG. 4 on page 45. The overall algorithm processes target rows from the top to the bottom, producing a result row for each loop.

Block 101 Initialize KIS uses the number of columns in the target and the number of columns in the kernel to allocate memory for a single kernel influence structure (KIS). This stage populates all of the substructures with zeros to represent the convolution kernel beginning completely above, and therefore not overlapping, the target. The row impact structures (RISs) in the KIS are labelled as having been created by rows that would exist above the target (negative indexes).

Block 102 Load Next RIS Shifts the convolution kernel down one row by loading the next target row down into a row impact structure (RIS). This overwrites the RIS for the row that is no longer overlapped by the kernel. To load rows that extend below the target, the RIS is loaded with zeros, reflecting that the kernel is extending beyond the bottom of the target.

Block 103 Compute Result Row uses the values in the current KIS to compute a full row of the convolution result, and store it.

Block 104 All Result Computed? performs the loop through the result rows until the full convolution result has been computed and stored.

Block 105 Target is the input convolution target.

Block 106 Kernel is the radially-symmetric convolution kernel being convolved over the target.

Block 107 Result is the convolution result from convolving the target with the kernel.

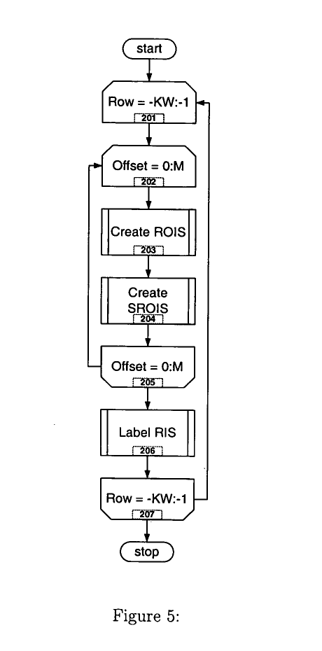

To initialize the kernel influence structure (KIS), a series of loops are used to create its substructures with zero values. FIG. 5 on page 46 shows this process.

Block 201 Row=−KW:−1 establishes a loop that creates row impact structures (RISs) for each row above the target image (thus the negative indexes). The kernel width (KW=\sqrt{N}) defines the number of RISs required (one for each row of the kernel).

Block 202 Offset=0:M establishes the loop required to create summed row offset impact structures (SROISs) for each positive offset of the kernel wherein the kernel still over-laps the row (M is the maximum offset). Because of symmetry, negative offsets are redundant and therefore not used. This set of SROISs constitute the current RIS.

Block 203 Create ROIS This allocates memory for a row offset impact structure and sets all values to zero.

Block 204 Create SROIS allocates memory for a single summed row offset impact structure and sets the values to zero.

Block 205 Row=−KW:−1 loops back to Block 201.

Block 206 Label RIS assigns the current value of ‘Row’ to the current row impact structure. This is essential to allow the RISs to be reused.

Block 207 Offset=0:M loops back to Block 202.

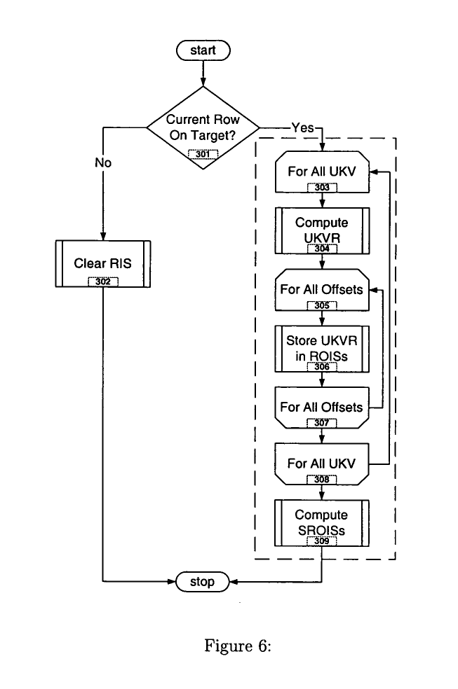

Each target row must be handled once. FIG. 6 on page 47 shows how each target row is loaded into a row impact structure (RIS).

Block 301 Current Row On Target? makes sure that, in the condition where the kernel has been shifted past the bottom of the target, zeros are padded into the structure. If the current row is on the target, then the standard Load RIS is performed.

Block 302 Clear RIS sets all summed row offset impact structures (SROISs) for the RIS to zeros. There is no need to clear the ROISs because they are not used once the SROIS is computed.

Block 303 For All UKV is a loop through all unique kernel values.

Block 304 Compute UKVR multiplies the entire target row by the current unique kernel value, creating the unique kernel value result (UKVR).

Block 305 For All Offsets is a loop through every offset the unique kernel value has within the radially-symmetric convolution kernel.

Block 306 Store UKVR In ROISs stores the UKVR in the ROIS matching the absolute value of the row offset. The UKVR is stored in the ROIS row matching the column of the kernel value, and the ROIS column matching KW minus the column (KW is the kernel width). The column of the kernel value is absolute position, versus offset from the centroid.

Block 307 For All Offsets loops back to Block 305.

Block 308 For All UKV loops back to Block 303.

Block 309 Compute SROISs sums the columns of each row offset impact structure (ROIS) into its associated summed row offset impact structure (SROIS).

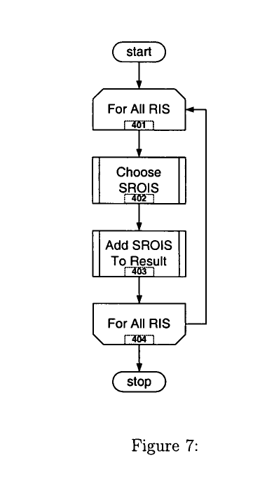

At each loop, the KIS indicates which result row should be computed next, and contains all of the intermediate data required to compute the result row. FIG. 7 on page 48 shows how each result row is computed.

Block 401 For All RIS loops through all row impact structures (RISs) in the kernel influence structure (KIS).

Block 402 Choose SROIS picks the summed row offset impact structure (SROIS) from the current RIS that represents the absolute value of the RIS's row to the current position of the convolution kernel.

Block 403 Add SROIS To Result adds the chosen SROIS into the current row of the convolution result.

Block 404 For All RIS loops back to Block.

To verify the algorithm's design and associated data structures, a demonstration was created in a Microsoft® Excel 2000 spreadsheet. The spreadsheet computes the convolution result for a 9 pixels×9 pixels target (T(:,:)) and a 9×9 convolution kernel (K(:,:)). For this demonstration, the result rows and columns associated with the kernel centroid being shifted off of the target are not computed (the result is cropped to the same dimensions as the target).

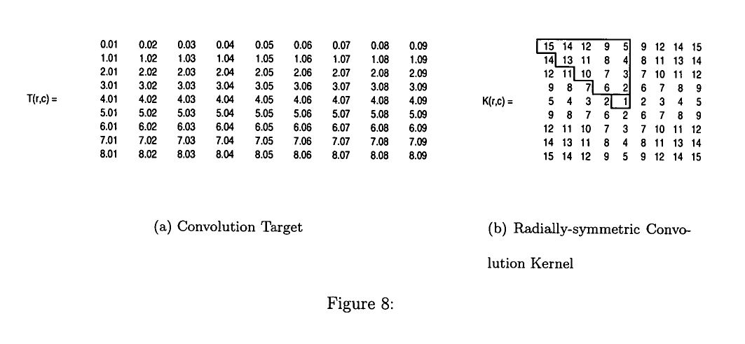

FIG. 8 on page 49 shows the input for the graphical example. The convolution target (FIG. 8(a)) is convolved/filtered by the radially-symmetric convolution kernel (FIG. 8(b)).

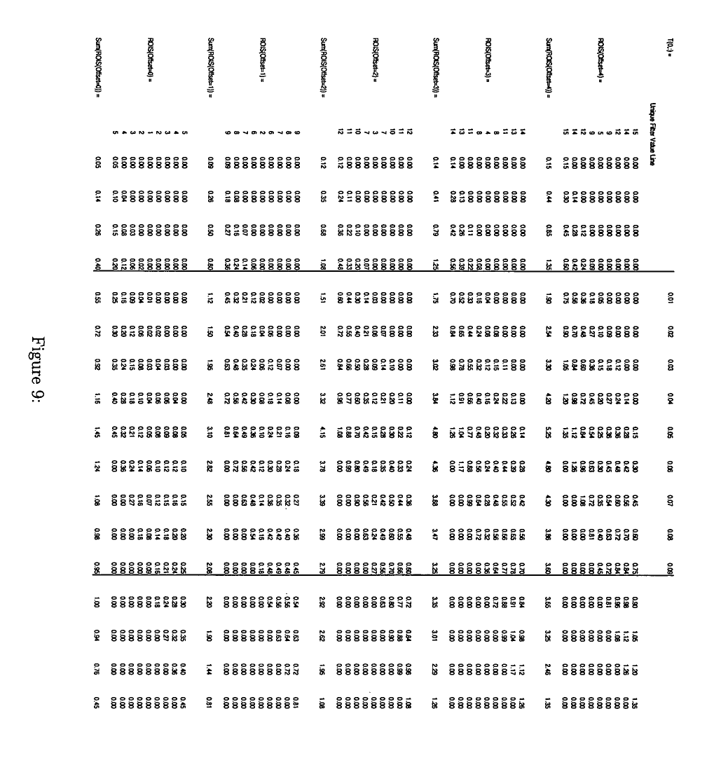

FIG. 9 on page 50 through 17 on page 58 show row impact structures (RISs) for each target row. Each RIS contains 5 row offset impact structures (ROISs), representing the central convolution kernel row (Offset=0) and the 4 row offsets (absolute value of the distance from the kernel centroid, in rows) for a kernel with 9 rows. Each ROIS has 9 rows, representing the 9 columns of the convolution kernel. The vertical borders show where the ROISs will be cropped.

Notice that the results written into rows of each ROIS are identical as they progress from the central row, except that they are shifted forward and backward by the offset from the central row. Values starting with 0.15 in the bottom row and first column of ROIS(Offset=4) match those in the top row of ROIS(Offset=4) starting in column 9. The bottom row is shifted forward ε (ε =4) and the top row is shifted backward E.

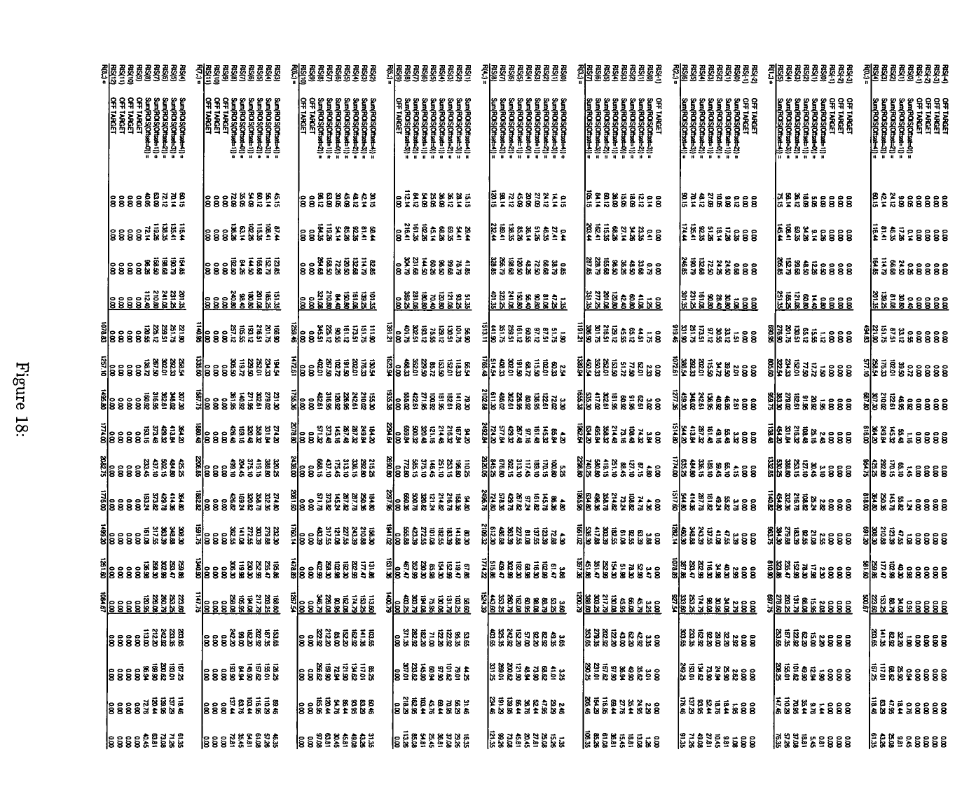

FIG. 18 on page 59 illustrates how each result row is computed. The figure shows 9 summed ROISs (SROISs) being summed to produce each result row. The 9 SROISs are from the rows the kernel is overlapping while centered on the corresponding target row (target rows −3 through +5 for result row 1). The SROIS chosen from each target row's RIS is determined by the row offset from the kernel's centroid (RIS(1) contributes SROIS(Offset=0) while RIS(3) contributes SROIS(Offset=2) for result row 1).

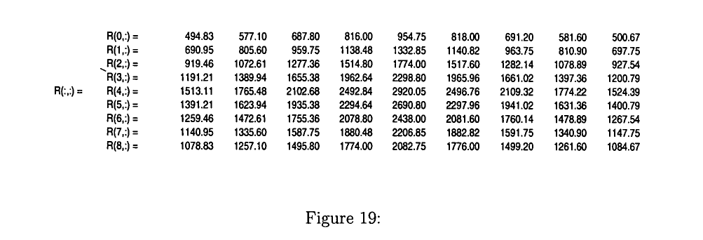

The Microsoft® Excel 2000 spreadsheet demonstration creates the convolution result in FIG. 19 on page 60. NOTE: this result has been cropped to match the dimension of the input target (FIG. 8(a) on page 49).

C. Vectorized Radially-Symmetric Convolution Design

The vectorized RSC design implements convolution with a kernel of arbitrary size with the following constraints:
1. Kernel is square—equal number of rows and columns
2. Kernel is odd dimensioned—odd number of rows and columns
3. Kernel is radially-symmetric—per equation 1 on page 4
4. Kernel has the same number (or less) rows and columns as the target
5. Kernel values must be stored in single-precision floating point format.

The vectorized RSC design implements convolution of a target image of arbitrary size with the following constraints:
1. Target must have as many, or more, rows and columns as the convolution kernel
2. Target must have η or more columns (where: η≡# of data elements that may be operated on simultaneously in the vector processor being used)
3. Target values must be stored in the format specified by the vector processor.

Further constraints that would benefit radially-symmetric convolution not currently relied upon in the design:
1. Allocate memory block on an address boundary for which the target vector processor is optimized (see vector processor documentation for recommendations)
2. Allocate memory block so that each row (for row-major images) or column (for column-major images) is padded with sufficient extra columns/rows so that every row (or column) begins at an address boundary for which the target vector processor is optimized.

The vectorized RSC design produces a convolution result image that is written to properly only if it exceeds the following constraints:
1. Result must have as many rows and columns as the convolution target image (for implementations that crop the result to the target image size) or be 2ε rows and columns larger than the target (for implementations that produce the full convolution result—not currently implemented)
2. Result must have been allocated in memory to extend to the next integer multiple of the vector processor's η after the final valid result value. NOTE: this allows all result data to be read or written in blocks of η values.
3. Result values must be stored in the format specified by the vector processor.

Additional constraints that would benefit radially-symmetric convolution are identical to the additional constraints for the convolution target.

The vectorized RSC implementation should produce only the result rows and columns associated with the convolution kernel centroid being centered on a target value. This effectively crops the result to the same size as the target. This is not a required constraint of the invention, as RSC is capable of computing all convolution results, however, it is a practical constraint that is used for this description of the implementation.

The following design principles are intended to exploit current CPU design to the fullest extent:
1. All data will be read from memory in blocks of η values.
2. All results (intermediate or final) will be written to memory in blocks of η values.
3. For each pass through memory, more data will be read to create the next result, than the data contained in the result (read faster/more than write)

In the vectorized design, values will be read into the registers that are off (to the left or right) of the target row. These values are masked by creating specialized block kernels for the left and right of the ROIS. These block kernels are computed at the very beginning of the algorithm, using the target width and kernel size to ensure that off-row values will be multiplied by zero.

The unique kernel value and target row result (UKVR) remains identical to the scalar UKVR in its structure and meaning. However, while the UKVR was stored into the row offset impact structure (ROIS) in contiguous memory for the scalar RSC design, the UKVR is computed in the CPU vector registers as blocks of η contiguous values, and directly summed into the summed row offset impact structure (SROIS).

The row offset impact structure (ROIS) remains identical to the scalar ROIS in its meaning. However, the ROIS is conceptual only in the vectorized implementation. It is a useful description of the handling of UKVRs that aids in the design and development of algorithms to compute the SROIS.

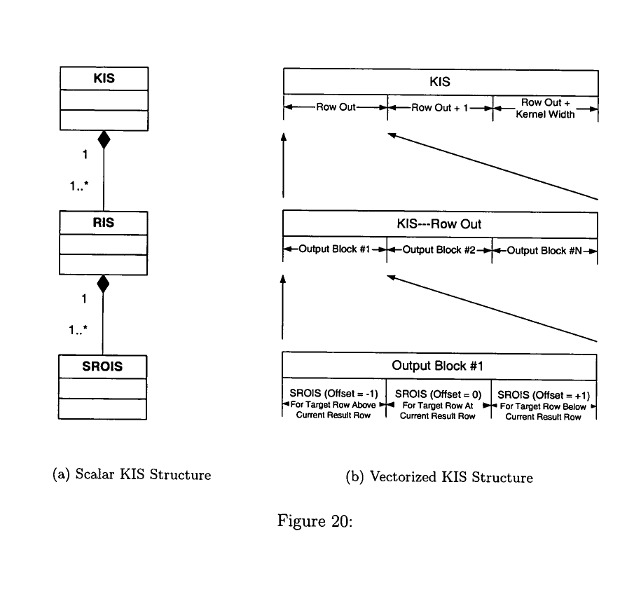

The summed row offset impact structure (SROIS) remains identical to the scalar SROIS in its meaning. However, while the SROIS was stored into the row impact structure (RIS) in contiguous memory for the scalar RSC design, the SROIS is broken into blocks of η contiguous values, and placed directly into the kernel influence structure (KIS) so that the results will be read contiguously from memory when computing a result row. This is shown in FIG. 20 on page 61.

After vectorization, the row impact structure is conceptual only. The SRIOSs it contains in the scalar RSC design, are written directly into a single contiguous block of memory in the KIS to facilitate the computation of result rows.

The kernel influence structure (KIS) remains identical to the scalar KIS in its meaning. However, it is no longer a container of RISs (which were containers of SROISs). It becomes a single contiguous chunk of memory, which can be viewed as broken into rows (where each row contains all of the data necessary to compute a single result row). This memory layout allows the computation of each block of η result values for a particular row to be the summation of contiguous blocks of η intermediate values from the correctly mixed SROISs. After the entire result row is computed, the KIS is ‘rotated.’ Rotating the KIS is simply changing which major block (or row) within the KIS that we consider the current major block. The major blocks are viewed as wrapping in memory so that they are circular. Incrementing the KIS pointer past the end of a major block resets the pointer to the first major block.

The KIS data structure is shown in FIG. 20 on page 61.

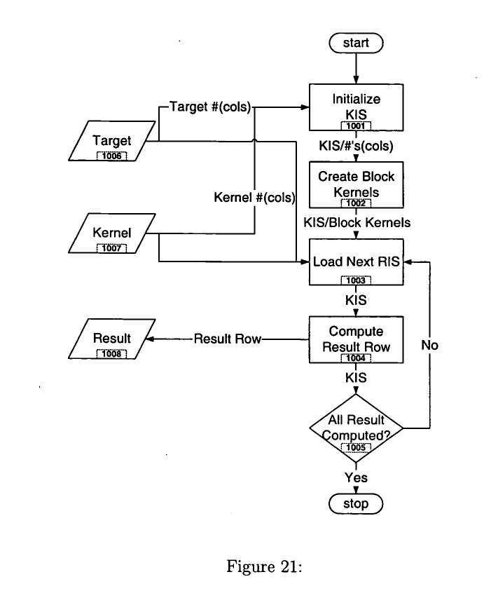

The top-level data flow is shown in FIG. 21 on page 62. The overall algorithm processes target rows from the top to the bottom, producing a result row for each loop. This diagram applies to the case where all convolution result rows and columns are computed. For practical use, only the result rows and columns where the kernel is centered on the target should be computed.

Block 1001 Initialize KIS uses the number of columns in the target and the number of columns in the kernel to allocate memory for a single kernel influence structure (KIS). This stage populates all of the substructures with zeros to represent the convolution kernel beginning completely above, and therefore not overlapping, the target.

Block 1002 Create Block Kernels creates specialized instances of the kernel as it will be applied to each target row. This step is vital to masking the off-row values that will be read into the vector registers along with on-row values in blocks of η values. This block simply mimics the processes defined in Block 1003 and its associated sub-block descriptions (2003, 2005, 2007), and saves the kernel values required to implement these steps. Therefore, during the loop over the rows, the kernel values can be loaded in blocks of η without being recomputed.

Block 1003 Load Next RIS shifts the convolution kernel one row down by loading the next target row down into the kernel influence structure (KIS). This overwrites the RIS for the row that is no longer overlapped by the kernel. To load rows that extent below the target, the RIS is loaded with zeros, reflecting that the kernel is extending beyond the bottom of the target. The RIS is conceptual only in the vectorized RSC algorithm. This RIS is a set of indices into the KIS where the target row's summed row offset impact structure (SROIS) values are stored.

Block 1004 Compute Result Row uses the values in the current KIS to compute a full row of the convolution result, and store it. This is accomplished by reading and summing contiguous blocks of η values. A set of η result values are stored at the end of each output block (as seen in FIG. 20 on page 61), and the accumulator is reset to zeros for the next output block.

Block 1005 All Result Computed? performs the loop through the result rows until the full convolution result has been computed and stored.

Block 1006 Target is the input convolution target.

Block 1007 Kernel is the radially-symmetric convolution kernel being convolved over the target.

Block 1008 Result is the convolution result from convolving the target with the kernel.

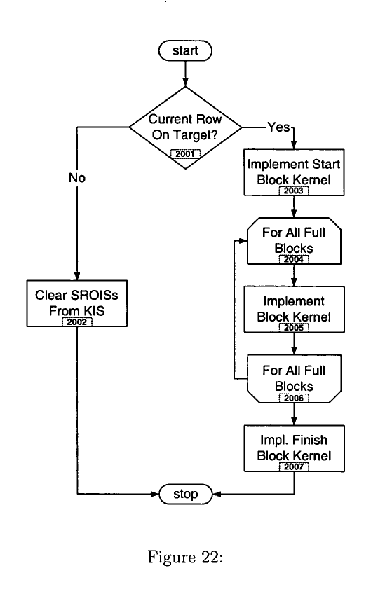

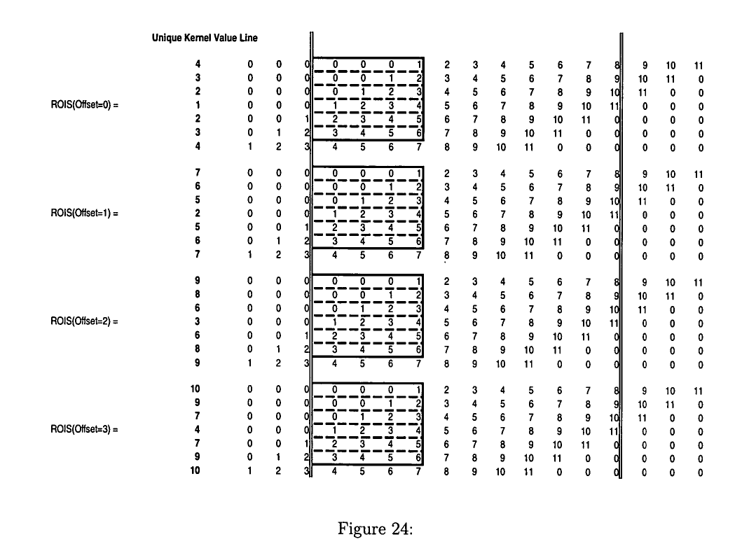

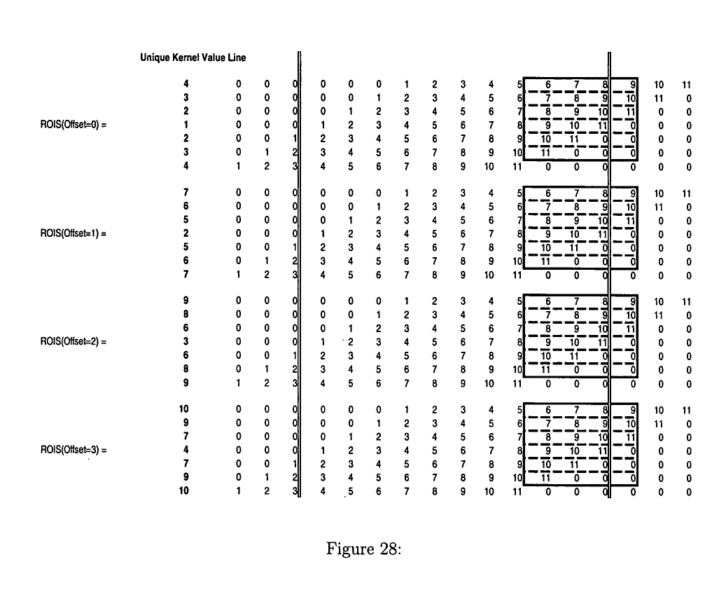

Each target row must be handled once. FIG. 22 on page 63 shows how each target row is loaded into a set of row offset impact structures (ROISs) and then summed into SROIS values that are stored throughout the kernel influence structure in a manner that facilitates the computation of result rows. Note the separate handling for leftmost (2003, below—see FIG. 24 on page 65), center (2005, below), and rightmost(2007, below—see FIG. 28 on page 69).

Block 2001 Current Row On Target? makes sure that, in the condition where the kernel has been shifted past the bottom of the target, zeros are padded into the structure. If the current row is on the target, then the target row is processed and loaded into the KIS.

Block 2002 Clear SROISs From KIS sets all summed row offset impact structure (SROIS) values for the current target row to zeros within the KIS.

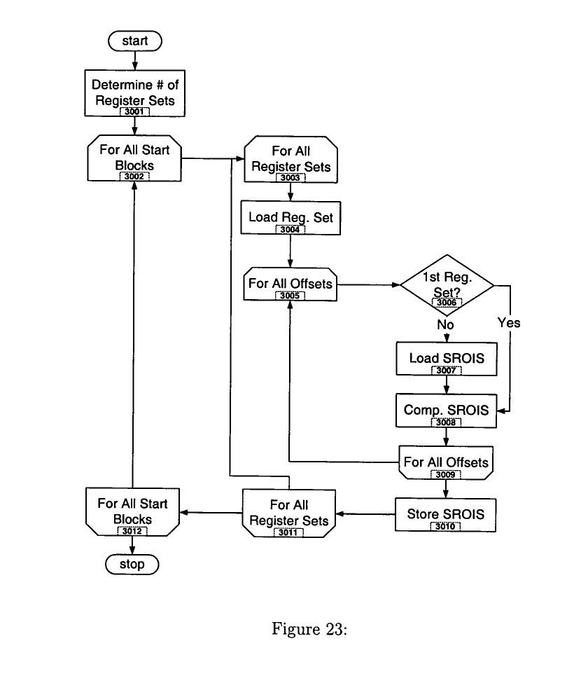

Block 2003 Implement Start Block Kernel loads the leftmost columns of the current target row into registers and uses the block kernel specialized for the leftmost columns to compute UKVRs (masked appropriately with zeros) and stores the resulting SROIS values into the KIS. This step is detailed in FIG. 23 on page 64.

Block 2004 For All Full Blocks begins the loop through the ROIS for all blocks of η values that do not require masking.

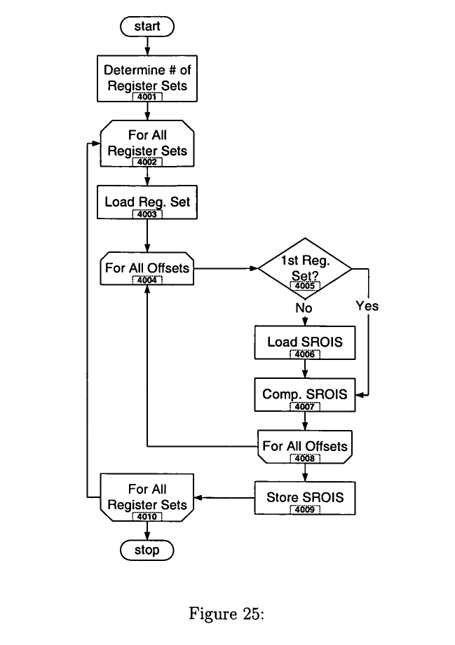

Block 2005 Implement Block Kernel computes the SROIS values (η at a time) for all blocks of η values in the ROIS that do not require masking. This step is detailed in FIG. 25 on page 66.

Block 2006 For All Full Blocks loops back to Block 2004.

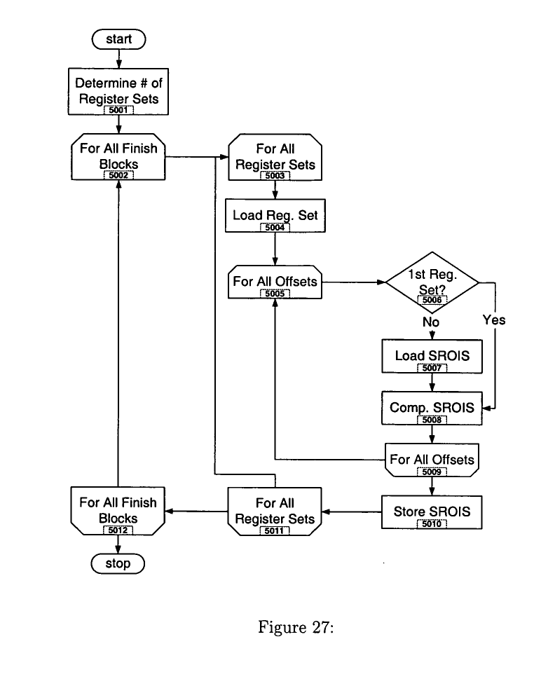

Block 2007 Impl. Finish Block Kernel loads the rightmost columns of the current target row into registers and uses the block kernel specialized for the rightmost columns to compute UKVRs (masked appropriately with zeros) and stores the resulting SROIS values into the KIS. This step is detailed in FIG. 27 on page 68.

To handle the condition where the radially-symmetric convolution kernel is extending beyond the left side of a row, a specialized block kernel is pre-computed to mask off-row values that will be read into the registers. FIG. 23 on page 64 shows how this block kernel is used to compute the leftmost summed row offset impact structure (SROIS) values.

Block 3001 Determine # of Register Sets computes the number of times that row offset impact structure (ROIS) rows must be loaded into registers to compute one block of η summed row offset impact structure (SROIS) values. There are a limited number of vector registers on any processor, making it impossible to guarantee that all ROIS rows can be loaded for any kernel size in a single pass. The number of vector registers available to hold ROIS rows is the total number of vector registers for the processor minus one register for scratch space and one register to accumulate the SROIS values. Therefore, if there are six vector registers available to hold ROIS rows, then a 7×7 convolution kernel (7 ROIS rows) will require two register set loads to process all ROIS rows. The boxed values in FIG. 24 on page 65 show the first register set that would be loaded.

Block 3002 For All Start Blocks begins the loop over all of the blocks of η columns in the ROIS that require masking of off-row values. In FIG. 24 on page 65 there is only one block of η columns containing off-row values.

Block 3003 For All Register Sets begins the loop over the register sets, as determined in Block 3001.

Block 3004 Load Reg. Set loads target row values into the register set, as seen in FIG. 24 on page 65. These values are loaded once and then reused for each ROIS. All shifting required for the ROIS is accomplished with unaligned reads in this block. The impact of unaligned reads is masked by the reuse of these values.

Block 3005 For All Offsets begins the loop through ROISs (each ROIS represents an offset from the kernel's centroid).

Block 3006 1st Reg. Set? ensures that if this is the first register set loaded for this ROIS, the accumulator begins with zeros. In the case that this is a subsequent register set pass, the incomplete SROIS values for this block are reloaded into the accumulator to continue accumulating the SROIS values for the current ROIS.

Block 3007 Load SROIS retrieves the previously stored, but incomplete summed row offset impact structure (SROIS) values from a previous register set for the current ROIS.

Block 3008 Comp. SROIS computes the portion of the summed row offset impact structure (SROIS) that can be computed given the target row values (ROIS row) loaded in the vector registers. During this process each of the registers containing target row values are copied to the scratch register and then multiplied in parallel by the appropriate block kernel values and accumulated into the SROIS values. This step uses the block kernel to multiply or mask target row values, η at a time, by the unique kernel value for their associated ROIS and ROIS row (see FIG. 24 on page 65).

Block 3009 For All Offsets loops back to Block 3005.

Block 3010 Store SROIS writes the SROIS values into the kernel influence structure (as dictated by the row impact structure).

Block 3011 For All Register Sets loops back to Block 3003.

Block 3012 For All Start Blocks loops back to Block 3002.

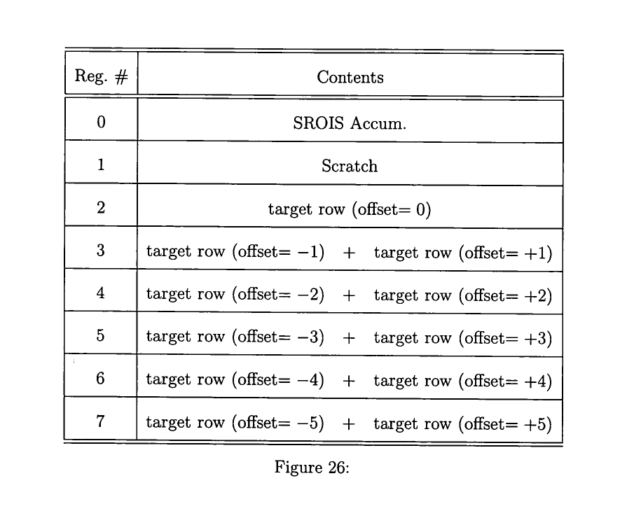

Because the central portion of the target row does not require masking in the row offset impact structure (ROIS), a general block kernel may be applied to compute and accumulate summed row offset impact structure (SROIS) values. This block kernel multiplies target row values by each unique kernel value η at a time. One further advantage is that the vector registers may be loaded by effectively folding the ROIS in half and pre-summing rows shifted forward and backward the same offset as seen in FIG. 26 on page 67.

Block 4001 Determine # of Register Sets computes the number of times that row offset impact structure (ROIS) rows must be loaded into registers to compute one block of η summed row offset impact structure (SROIS) values. There are a limited number of vector registers on any processor, making it impossible to guarantee that all ROIS rows can be loaded for any kernel size in a single pass. The number of vector registers available to hold ROIS rows is the total number of vector registers for the processor minus one register for scratch space and one register to accumulate the SROIS values. If there are 6 vector registers available to hold ROIS rows, then, as seen in FIG. 26 on page 67, the center row plus 5 pairs of rows can be loaded in the first pass, and 6 pairs of rows can be loaded in any subsequent pass. This means that up to an 11×11 kernel can be implemented in a single pass, and up to a 23×23 kernel can be implemented in two passes. This folding of the ROIS is very important in efficiency and dramatically reduces the total amount of memory accesses required.

Block 4002 For All Register Sets begins the loop over the register sets, as determined in Block 4001.

Block 4003 Load Reg. Set loads target row values into the register set, as seen in FIG. 26 on page 67. These values are loaded once and then reused for each ROIS. All shifting required for the ROIS is accomplished with unaligned reads in this block. The impact of unaligned reads is masked by the reuse of these values.

Block 4004 For All Offsets begins the loop through ROISs (each ROIS represents an offset from the kernel's centroid).

Block 4005 1st Reg. Set? ensures that if this is the first register set loaded for this ROIS, the accumulator begins with zeros. In the case that this is a subsequent register set pass, the incomplete SROIS values for this block are reloaded into the accumulator to continue accumulating the SROIS values for the current ROIS.

Block 4006 Load SROIS retrieves the previously stored, but incomplete summed row offset impact structure (SROIS) values from a previous register set for the current ROIS.

Block 4007 Comp. SROIS computes the portion of the summed row offset impact structure (SROIS) that can be computed given the target row values (ROIS row) loaded in the vector registers. During this process each of the registers containing target row values (or pre-summed pairs of target row values) are copied to the scratch register and then multiplied in parallel by the appropriate block kernel values and accumulated into the SROIS values. This step uses the block kernel to multiply or mask target row values, η at a time, by the unique kernel value for their associated ROIS and ROIS row (see FIG. 24 on page 65).

Block 4008 For All Offsets loops back to Block 3005.

Block 4009 Store SROIS writes the SROIS values into the kernel influence structure (as dictated by the row impact structure).

Block 4010 For All Register Sets loops back to Block 4002.

To handle the condition where the radially-symmetric convolution kernel is extending beyond the right side of a row, a specialized block kernel is pre-computed to mask off-row values that will be read into the registers. FIG. 27 on page 68 shows how this block kernel is used to compute the rightmost summed row offset impact structure (SROIS) values.

Block 5001 Determine # of Register Sets computes the number of times that row offset impact structure (ROIS) rows must be loaded into registers to compute one block of η summed row offset impact structure (SROIS) values. There are a limited number of vector registers on any processor, making it impossible to guarantee that all ROIS rows can be loaded for any kernel size in a single pass. The number of vector registers available to hold ROIS rows is the total number of vector registers for the processor minus one register for scratch space and one register to accumulate the SROIS values. Therefore, if there are six vector registers available to hold ROIS rows, then a 7×7 convolution kernel (7 ROIS rows) will require two register set loads to process all ROIS rows. The boxed values in FIG. 28 on page 69 show the first register set that would be loaded.

Block 5002 For All Start Blocks begins the loop over all of the blocks of η columns in the ROIS that require masking of off-row values. In FIG. 28 on page 69 there is only one block of η columns containing off-row values.

Block 5003 For All Register Sets begins the loop over the register sets, as determined in Block 5001.

Block 5004 Load Reg. Set loads target row values into the register set, as seen in FIG. 28. These values are loaded once and then reused for each ROIS. All shifting required for the ROIS is accomplished with unaligned reads in this block. The impact of unaligned reads is masked by the reuse of these values.

Block 5005 For All Offsets begins the loop through ROISs (each ROIS represents an offset from the kernel's centroid).

Block 5006 1st Reg. Set? ensures that if this is the first register set loaded for this ROIS, the accumulator begins with zeros. In the case that this is a subsequent register set pass, the incomplete SROIS values for this block are reloaded into the accumulator to continue accumulating the SROIS values for the current ROIS.

Block 5007 Load SROIS retrieves the previously stored, but incomplete summed row offset impact structure (SROIS) values from a previous register set for the current ROIS.

Block 5008 Comp. SROIS computes the portion of the summed row offset impact structure (SROIS) that can be computed given the target row values (ROIS row) loaded in the vector registers. During this process each of the registers containing target row values are copied to the scratch register and then multiplied in parallel by the appropriate block kernel values and accumulated into the SROIS values. This step uses the block kernel to multiply or mask target row values, η at a time, by the unique kernel value for their associated ROIS and ROIS row (see FIG. 28 on page 69).

Block 5009 For All Offsets loops back to Block 5005.

Block 5010 Store SROIS writes the SROIS values into the kernel influence structure (as dictated by the row impact structure).

Block 5011 For All Register Sets loops back to Block 5003.

Block 5012 For All Start Blocks loops back to Block 5002.

D. Performance

FLOPs are used herein to scope and demonstrate the general growth of computations required for different target and kernel sizes. The number of FLOPs required does not specify the time required to perform convolution (see Table 1 on page 3 for additional factors on performance), but it does directly relate to the time required. FLOPs will not be used as a measure of performance for the final algorithm and/or MATLAB® prototype.

Execution time should be measured for the implemented algorithm on the ‘average’ (4,879 pixels×2,322 pixels), ‘smallest’ (2,592 pixels×736 pixels), and ‘largest’ (6,688 pixels×5,472 pixels) size image as computed for this document, using a kernel size of 17 pixels×17 pixels. This should be compared to the intrinsic MATLAB® conv2 command's run time.

The intrinsic MATLAB®) conv2 command's run time is shown in Table 3 on the following page. The ‘largest’ result is not shown because it required the use of swap space. The expected performance of the vectorized radially-symmetric convolution implementation is also shown in the table. This assumes that the approximate speed up from the algorithm is a factor of 6.

TABLE 3
Expected Vectorized Radially-symmetric Convolution Performance
Execution time to convolve the ‘average’ (4,879 pixels × 2,322 pixels),
‘smallest’ (2,592 pixels × 736 pixels), and ‘largest’ (6,688 pixels ×
5,472 pixels) size image as computed for this document, using a kernel
size of 17 pixels × 17 pixels.

| Target | MATLAB ® | RSC Expected |
|---|---|---|
| average | 71 seconds | 12 seconds |
| smallest | 11 seconds | 1½ seconds |
| largest | Not Measured | Not Estimated |

1. A method for filtering an array of input data with a radially-symmetric convolution (RSC) kernel comprising:
(a) positioning the convolution kernel so that it overlaps a row of input data;
(b) identifying all unique values in the RSC kernel;
(c) multiplying each unique value with the selected input row to produce a set of Unique Kernel Value Results (UKVRs);
(d) computing a set of Row Offset Impact Structures (ROISs) using the UKVRs;
(e) computing a set of Summed Row Offset Impact Structure (SROISs) from the ROISs;
(f) creating a Row Impact Structure (RIS) containing the SROISs;
(g) loading the RIS into a Kernel Influence Structure (KIS);
(h) computing an output row from the KIS;
(i) shifting the position of the convolution kernel so that it overlaps a new input row by rotating the position of all RISs, and removing the row's RIS which will no longer be overlapped by the kernel; and
(j) repeating steps b) through i) until all result rows have been computed.

2. A method, as in claim 1, where input data are sampled at one or more rates, depending on the dimension.

3. A method for filtering an array of input data with a radially-symmetric convolution (RSC) kernel comprising:
(a) positioning the convolution kernel so that it overlaps a row of input data;
(b) identifying all unique values in the RSC kernel;
(c) multiplying each unique value with the selected input row to produce a set of Unique Kernel Value Results (UKVRs);
(d) computing a set of Summed Row Offset Impact Structure (SROISs) using the UKVRs;
(e) creating a Row Impact Structure (RIS) containing the SROISs;
(f) loading the RIS into a Kernel Influence Structure (KIS);
(g) computing an output row from the KIS;
(h) shifting the position of the convolution kernel so that it overlaps a new input row by rotating the position of all RISs, and removing the row's RIS which will no longer be overlapped by the kernel; and
(i) repeating steps b) through i) until all result rows have been computed.

4. A method, as in claim 2, where input data are sampled at one or more rates, depending on the dimension.
